(19) United States
(12) Patent Application Publication
(10) Pub. No.: US 2014/0309354 A1
(43) Pub. Date: Oct. 16, 2014

(54) Reduced Volatility Polyarylene Sulfide

(71) Applicant: Ticona LLC, Florence, KY (US)

(72) Inventors: Ke Feng, Cincinnati, OH (US); Paul Yung, Cincinnati, OH (US)

(73) Assignee: Ticona LLC, Florence, KY (US)

(21) Appl. No.: 14/245,417

(22) Filed: Apr. 4, 2014

Related U.S. Application Data
(60) Provisional application No. 61/811,325, filed on Apr. 12, 2013.
(60) Provisional application No. 61/858,797, filed on Jul. 26, 2013.

(51) Int. Cl. C08K 3/34; C08L 81/04

(52) U.S. Cl. CPC C08K 3/34; C08L 81/04
USPC 524/450; 525/537; 264/41

(57) ABSTRACT

Thermoplastic compositions that incorporate a polyarylene sulfide and exhibit reduced volatility are described. Methods for forming the thermoplastic composition are also described as are products that can incorporate the compositions. A formation method can include melt processing the composition and incorporating a molecular sieve in the composition downstream of the addition point for the polyarylene sulfide as well as downstream of additives that could interact with the molecular sieve such as coupling agents.

### CROSS REFERENCE TO RELATED APPLICATION

The present application claims filing benefit of U.S. Provisional Patent Application Ser. No. 61/811,325 having a filing date of Apr. 12, 2013 and U.S. Provisional Patent Application Ser. No. 61/858,797 having a filing date of Jul. 26, 2013, both of which are incorporated herein in their entirety by reference.

### BACKGROUND OF THE INVENTION

Polyarylene sulfides are high-performance polymers that may withstand high thermal, chemical, and mechanical stresses and are beneficially utilized in a wide variety of applications. Polyarylene sulfides are generally formed via polymerization of p-dichlorobenzene with an alkali metal sulfide or an alkali metal hydrosulfide.

These polymers have advantageously been utilized to form composite products that include components formed of thermoplastic compositions including the high performance polyarylene sulfide polymers in combination with components formed of other materials such as metals. In forming a composite the individual components have been joined by many different methods including the use of adhesives and adhesive-free direct molding processes such as overmolding. The method of joining a thermoplastic component to a second component often entails a high temperature step to ensure that the bond between the components is fully developed and/or cured. Unfortunately, at the requisite temperatures, residuals in the thermoplastic composition can volatilize, which can lead to negative results such as unpleasant odors and contamination of the local atmosphere during processing and use. For instance, volatiles released over the lifetime of the part can coat nearby surfaces, affecting transparency or other desirable characteristics of the surface.

The volatility of thermoplastic compositions can also cause problems such as unpleasant odor over the life of a product, and not only for composite products. To ensure that products formed from polyarylene sulfides will not emit unpleasant odors over time, a separate heating step is often included in the formation process. This step can drive off volatile components of the thermoplastic composition so as to prevent unpleasant odors during the life of the product due to slow volatilization over time. Unfortunately, however, such processing can add to the overall costs of formation.

What are needed in the art are thermoplastic compositions of polyarylene sulfides that exhibit reduced volatility while maintaining desirable strength and processability characteristics.

### SUMMARY OF THE INVENTION

Disclosed in one embodiment is a thermoplastic composition that exhibits reduced volatility. The thermoplastic composition includes a polyarylene sulfide and a molecular sieve that has a small average pore diameter, for instance an average pore diameter of less than about 15 angstroms. The thermoplastic composition can optionally include other additives such as, without limitation, a coupling agent, fibrous fillers, and so forth.

Products incorporating a melt-processed thermoplastic composition are also disclosed. Products can include, for example, devices that incorporate overmoldings such as electronic devices. For instance, computers and computer equipment as well as portable electronic devices such as laptop computers, tablet computers, telephones, media devices, gaming devices, etc. can incorporate the thermoplastic. Other products encompassed are those that include an enclosed assembly and generate high temperatures during use such as housings for light fixture. Products that require heat curing or thermal advancing in a closed environment during formation such as electronics and medical equipment and products that can be used in a high temperature atmosphere such as those found in food preparation applications can also beneficially incorporate the thermoplastic composition.

Also disclosed is a method for forming a thermoplastic composition. For instance, a method can include feeding a polyarylene sulfide polymer to a melt processing unit. A method can also include feeding a molecular sieve to the melt processing unit. More specifically, the molecular sieve can be fed to the melt processing unit at a downstream location, for instance downstream of the polyarylene sulfide and, when present, downstream of any coupling agents that may be included in the thermoplastic composition.

### BRIEF DESCRIPTION OF THE FIGURES

The present disclosure may be better understood with reference to the following figures:

FIG. 1 is a schematic representation of a process for forming a thermoplastic composition as disclosed herein.

FIG. 2 is a cross-sectional view of one embodiment of an injection mold apparatus that may be employed in the present invention.

FIG. 3 illustrates a water pump that may be formed in accordance with one embodiment of the present invention.

FIG. 4 is a perspective view of an electronic device that contains an overmolding that includes a melt processed thermoplastic composition in accordance with one embodiment of the present disclosure.

FIG. 5 is a perspective view of the electronic device of FIG. 2, shown in a closed configuration.

FIG. 6 is a perspective view of an enclosed lighting fixture that may incorporate the thermoplastic composition.

### DETAILED DESCRIPTION

It is to be understood by one of ordinary skill in the art that the present discussion is a description of exemplary embodiments only, and is not intended as limiting the broader aspects of the present invention.

The present disclosure is generally directed to thermoplastic compositions that incorporate a polyarylene sulfide and exhibit reduced volatility. Beneficially, the thermoplastic composition can exhibit reduced volatility while also having desirable physical characteristics. In other words, the materials and processes utilized to provide the reduced volatility of the thermoplastic compositions do not negatively affect the physical characteristics of the thermoplastic composition. More specifically, other physical characteristics of the thermoplastic composition such as tensile characteristics, strength characteristics, temperature response characteristics, etc. can be essentially the same (i.e., within about ±5%) of a thermoplastic composition that differs only by the presence of the molecular sieve. By way of example, the thermoplastic composition can exhibit a tensile strength at break of greater than about 100 megapascals (MPa), greater than about 110 MPa, or greater than about 120 MPa and can exhibit a tensile elongation at yield of greater than about 0.5%, greater than about 0.7%, or greater than about 0.9%. Tensile characteristics can be determined according to ISO Test No. 527 at a temperature of 23° C. and a test speed of 5 mm/min.

The thermoplastic composition can likewise exhibit an excellent deflection temperature under load (DTUL). For instance, the thermoplastic composition can exhibit a DTUL of greater than about 250° C., or greater than about 260° C. as determined according to ASTM D648-07 (technically equivalent to ISO Test No. 75-2) at a specified load of 1.8 MPa. The thermoplastic composition can exhibit an Izod notched impact strength (Notched Izod) as determined according to ISO Test No. 80 (technically equivalent to ASTM D256) of greater than about 4 kJ/m², or greater than about 5 kJ/m² measured at 23° C.

The melt viscosity of the thermoplastic composition can vary, generally depending upon the melt viscosity of the polyarylene sulfide polymer included in the thermoplastic composition as is known in the art. For instance, the melt viscosity of the composition can be less than about 5 kPa/sec in one embodiment, for instance in an embodiment in which a low melt viscosity polyarylene sulfide is utilized in forming the composition or can have a melt viscosity of greater than about 5 kPa/sec in those embodiments in which a higher melt viscosity polymer is utilized in forming the composition. A preferred melt viscosity for the composition can generally vary depending upon the processing methods to be utilized in forming a product as well as the final product to be formed by the process, as is generally known in the art.

In one embodiment, the thermoplastic composition may possess a relatively low melt viscosity, which allows it to readily flow into the mold cavity during production of a part in an injection molding operation. For instance, the composition may have a melt viscosity of about 20 kilopoise or less, in some embodiments about 15 kilopoise or less, and in some embodiments, from about 0.1 to about 10 kilopoise, as determined by a capillary rheometer at a temperature of 316° C. and shear rate of 1200 seconds⁻¹. Among other things, these viscosity properties can allow the composition to be readily injection molded into parts having very small dimensions without producing excessive amounts of flash.

The thermoplastic composition can be formed according to a melt processing technique that includes combining a polyarylene sulfide with a molecular sieve having certain characteristics as described in more detail herein. More specifically, the molecular sieve can be combined with the polyarylene sulfide following melt of the polyarylene sulfide in the melt processing unit, e.g., downstream of the initial feed in a melt extruder. In addition, the molecular sieve can be combined with the polyarylene sulfide downstream of the addition site of any coupling agents that are included in the thermoplastic composition. For instance, a coupling agent can be combined with the polyarylene sulfide at a main feed and the molecular sieve can be combined with these components of the composition at a downstream feed of the melt processing unit.

Without being bound to any particular theory, it is believed that by combing the molecular sieve with the polyarylene sulfide following melt of the polyarylene sulfide, interaction of the molecular sieve with components of the thermoplastic composition within the melt processing unit can be decreased, which can minimize the possibility of undesirable reaction between the molecular sieve and other components of the thermoplastic composition. For instance, it is believed that interaction between a coupling agent and the molecular sieve can lead to a loss of activity level of the molecular sieve, which in turn can increase the volatility of the thermoplastic composition. Thus, by minimizing interaction between the molecular sieve and components of the thermoplastic composition within the melt processing unit the volatility of the thermoplastic composition can be decreased as compared to other, previously known thermoplastic compositions.

The thermoplastic composition can exhibit a lower loss of volatile compounds as compared to a similar composition but for the presence of the molecular sieve. For instance, following heat treatment at a temperature of 230° for a period of 4 hours, the thermoplastic composition can have a total loss of volatile compounds that is about 98% or less, about 75% or less, about 60% or less, about 50% or less, or about 40% or less of a similar composition that varies only by the absence of the molecular sieve.

In addition to exhibit a lower loss of volatile compounds, the thermoplastic composition can in one embodiment exhibit a reduced cooling time. According to this embodiment, the thermoplastic composition can include in addition to the polyarylene sulfide and the molecular sieve, a boron-containing nucleating agent. By selectively controlling certain aspects of the polyarylene sulfide, the molecular sieve, and the nucleating agent, as well as the particular manner in which they are combined, the present inventors have discovered that the crystallization properties of the resulting thermoplastic composition can be significantly improved. Among other things, this allows the “cooling time” during a molding cycle of an injection molding process to be substantially reduced while still achieving the same degree of crystallization. The cooling time can be represented by the “normalized cooling ratio”, which is determined by dividing the total cooling time by the average thickness of a section of the molded part. As a result of the present invention, for example, the normalized cooling ratio may range from about 0.2 to about 8 seconds per millimeter, in some embodiments from about 0.5 to about 6 seconds per millimeter, and in some embodiments, from about 1 to about 5 seconds per millimeter. The total cooling time can be determined from the point when the composition is injected into the mold cavity to the point that it reaches an ejection temperature at which it can be safely ejected. Exemplary cooling times may range, for instance, from about 1 to about 60 seconds, in some embodiments from about 5 to about 40 seconds, and in some embodiments, from about 10 to about 35 seconds. Likewise, exemplary average thicknesses for one or more sections of the injection molded parts formed from a thermoplastic composition may be about 25 millimeters or less, in some embodiments from about 0.5 to about 15 millimeters, and in some embodiments, from about 1 millimeter to about 10 millimeters.

In addition to minimizing the required cooling time for a molding cycle, the method and composition of the present invention can also allow parts to be molded at lower temperatures while still achieving the same degree of crystallization. For example, the injection mold temperature (e.g., temperature of a surface of the mold) may be from about 50° C. to about 120° C., in some embodiments from about 60° C. to about 110° C., and in some embodiments, from about 70° C. to about 90° C. In addition to minimizing the energy requirements for the molding operation, such low mold temperatures may be accomplished using cooling mediums that are less corrosive and expensive than some conventional techniques. For example, liquid water may be employed as a cooling medium. Further, the use of low mold temperatures can also decrease the production of “flash” normally associated with high temperature molding operations. For example, the length of any flash (also known as burrs) created during a molding operation may be about 0.17 millimeters or less, in some embodiments about 0.14 millimeters or less, and in some embodiments, about 0.13 millimeters or less.

FIG. 1 illustrates a schematic of a process that can be used in forming the thermoplastic composition. As illustrated, the components of the composition may be melt-kneaded in a melt processing unit such as an extruder 100. Extruder 100 can be any extruder as is known in the art including, without limitation, a single, twin, or multi-screw extruder, a co-rotating or counter rotating extruder, an intermeshing or non-intermeshing extruder, and so forth. In one embodiment, the composition may be melt processed in an extruder 100 that includes multiple zones or barrels. In the illustrated embodiment, extruder 100 includes 10 barrels numbered 121-130 along the length of the extruder 100, as shown. Each barrel 121-130 can include feed lines 114, 116, vents 112, temperature controls, etc. that can be independently operated. A general purpose screw design can be used to melt process the thermoplastic composition. By way of example, a thermoplastic composition may be melt mixed using a twin screw extruder such as a WLE or Werner & Phladerer co-rotating fully intermeshing twin screw extruder.

In forming the thermoplastic composition, a polyarylene sulfide can be fed to the extruder 100 at a main feed throat 114. For instance, the polyarylene sulfide may be fed to the main feed throat 114 at the first barrel 121 by means of a volumetric feeder. The polyarylene sulfide can be melted and mixed with the other components of the composition as it progresses through the extruder 100. At a point downstream of the main feed throat 114, the molecular sieve can be added to the polyarylene sulfide. For instance, in the illustrated embodiment, a second feed line 116 at barrel 124 can be utilized for addition of the molecular sieve. The point of addition for the molecular sieve is not particularly limited. However, the molecular sieve can be added to the composition at a point after the polyarylene sulfide has melted and following addition of any components that can interact with the molecular sieve, such as a coupling agent.

In general, the polyarylene sulfide may be a polyarylene thioether containing repeat units of the formula (I):

-[(Ar¹)ₙ—X]ₘ—[(Ar²)ᵢ—Y]ⱼ—[(Ar³)ₖ—Z]ₗ—[(Ar⁴)ₒ—W]ₚ- (I)

wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes more than about 30 mol %, more than about 50 mol %, or more than about 70 mol % arylene sulfide (—S—) units. In one embodiment the polyarylene sulfide includes at least 85 mol % sulfide linkages attached directly to two aromatic rings.

The polyarylene sulfide may be synthesized during the process of forming the thermoplastic composition, though this is not a requirement, and a polyarylene sulfide can also be purchased from known suppliers. For instance Fortron® polyphenylene sulfide available from Ticona of Florence, Ky., USA can be purchased and utilized in forming the thermoplastic composition.

Synthesis techniques that may be used in forming a polyarylene sulfide are generally known in the art. By way of example, a process for producing a polyarylene sulfide can include reacting a material that provides a hydrosulfide ion, e.g., an alkali metal sulfide, with a dihaloaromatic compound in an organic amide solvent.

The alkali metal sulfide can be, for example, lithium sulfide, sodium sulfide, potassium sulfide, rubidium sulfide, cesium sulfide or a mixture thereof. When the alkali metal sulfide is a hydrate or an aqueous mixture, the alkali metal sulfide can be processed according to a dehydrating operation in advance of the polymerization reaction. An alkali metal sulfide can also be generated in situ. In addition, a small amount of an alkali metal hydroxide can be included in the reaction to remove or react impurities (e.g., to change such impurities to harmless materials) such as an alkali metal polysulfide or an alkali metal thiosulfate, which may be present in a very small amount with the alkali metal sulfide.

The dihaloaromatic compound can be, without limitation, an o-dihalobenzene, m-dihalobenzene, p-dihalobenzene, dihalotoluene, dihalonaphthalene, methoxy-dihalobenzene, dihalobiphenyl, dihalobenzoic acid, dihalodiphenyl ether, dihalodiphenyl sulfone, dihalodiphenyl sulfoxide or dihalodiphenyl ketone. Dihaloaromatic compounds may be used either singly or in any combination thereof. Specific exemplary dihaloaromatic compounds can include, without limitation, p-dichlorobenzene; m-dichlorobenzene; o-dichlorobenzene; 2,5-dichlorotoluene; 1,4-dibromobenzene; 1,4-dichloronaphthalene; 1-methoxy-2,5-dichlorobenzene; 4,4′-dichlorobiphenyl; 3,5-dichlorobenzoic acid; 4,4′-dichlorodiphenyl ether; 4,4′-dichlorodiphenylsulfone; 4,4′-dichlorodiphenylsulfoxide; and 4,4′-dichlorodiphenyl ketone.

The halogen atom can be fluorine, chlorine, bromine or iodine, and 2 halogen atoms in the same dihalo-aromatic compound may be the same or different from each other. In one embodiment, o-dichlorobenzene, m-dichlorobenzene, p-dichlorobenzene or a mixture of 2 or more compounds thereof is used as the dihalo-aromatic compound.

As is known in the art, it is also possible to use a monohalo compound (not necessarily an aromatic compound) in combination with the dihaloaromatic compound in order to form end groups of the polyarylene sulfide or to regulate the polymerization reaction and/or the molecular weight of the polyarylene sulfide.

The polyarylene sulfide may be a homopolymer or may be a copolymer. By a suitable, selective combination of dihaloaromatic compounds, a polyarylene sulfide copolymer can be formed containing not less than two different units. For instance, in the case where p-dichlorobenzene is used in combination with m-dichlorobenzene or 4,4′-dichlorodiphenylsulfone, a polyarylene sulfide copolymer can be formed containing segments having the structure of formula (II):

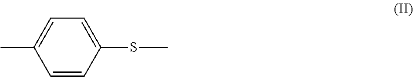

and segments having the structure of formula (III).

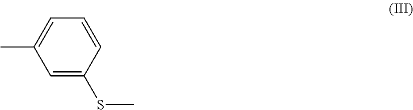

or segments having the structure of formula (IV):

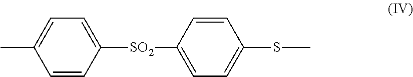

In general, the amount of the dihaloaromatic compound(s) per mole of the effective amount of the charged alkali metal sulfide can generally be from 1.0 to 2.0 moles, from 1.05 to 2.0 moles, or from 1.1 to 1.7 moles. Thus, the polyarylene sulfide can include alkyl halide (generally alkyl chloride) end groups.

In another embodiment, a polyarylene sulfide copolymer may include a first segment with a number-average molar mass Mn of from 1000 to 20,000 g/mol that includes first units that have been derived from structures of the formula (V):

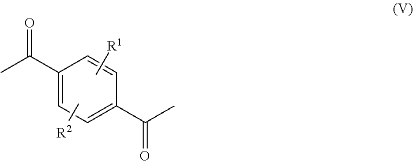

where the radicals R¹ and R², independently of one another, are a hydrogen, fluorine, chlorine or bromine atom or a branched or unbranched alkyl or alkoxy radical having from 1 to 6 carbon atoms; and/or second units that are derived from structures of the formula (VI):

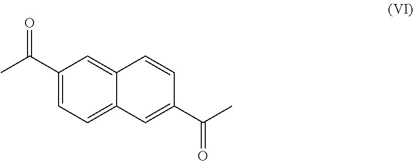 [SMILES: CC(=O)c1ccc2cc(C(C)=O)ccc2c1]

The first unit may be p-hydroxybenzoic acid or one of its derivatives, and the second unit may be composed of 2-hydroxynaphthalene-6-carboxylic acid.

A polyarylene sulfide copolymer can include a second segment derived from a polyarylene sulfide structure of the formula (VII):

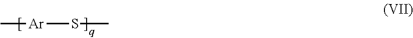

where Ar is an aromatic radical, or more than one condensed aromatic radical, and q is a number from 2 to 100, in particular from 5 to 20. The radical Ar in formula (VII) may be a phenylene or naphthylene radical. In one embodiment, the second segment may be derived from poly(m-thiophenylene), from poly(o-thiophenylene), or from poly(p-thiophenylene).

The first segment of a polyarylene sulfide copolymer may include both the first and second units. The first and second units may be arranged with random distribution or in alternating sequence in the first segment. The molar ratio of the first and second units in the first segment may be from 1:9 to 9:1.

As stated, a process for producing the polyarylene sulfide can include carrying out the polymerization reaction in an organic amide solvent. Exemplary organic amide solvents used in a polymerization reaction can include, without limitation, N-methyl-2-pyrrolidone; N-ethyl-2-pyrrolidone; N,N-dimethylformamide; N,N-dimethylacetamide; N-methylcaprolactam; tetramethylurea; dimethylimidazolidinone; hexamethyl phosphoric acid triamide and mixtures thereof. The amount of the organic amide solvent used in the reaction can be, e.g., from 0.2 to 5 kilograms per mole (kg/mol) of the effective amount of the alkali metal sulfide.

The polymerization can be carried out by a step-wise polymerization process. The first polymerization step can include introducing the dihaloaromatic compound to a reactor, and subjecting the dihaloaromatic compound to a polymerization reaction in the presence of water at a temperature of from about 180° C. to about 235° C., or from about 200° C. to about 230° C., and continuing polymerization until the conversion rate of the dihaloaromatic compound attains to not less than about 50 mol % of the theoretically necessary amount.

In a second polymerization step, water is added to the reaction slurry so that the total amount of water in the polymerization system is increased to about 7 moles, or to about 5 moles, per mole of the effective amount of the charged alkali metal sulfide. Following, the reaction mixture of the polymerization system can be heated to a temperature of from about 250° C. to about 290° C., from about 255° C. to about 280° C., or from about 260° C. to about 270° C. and the polymerization can continue until the melt viscosity of the thus formed polymer is raised to the desired final level of the polyarylene sulfide. The duration of the second polymerization step can be, e.g., from about 0.5 to about 20 hours, or from about 1 to about 10 hours.

The polyarylene sulfide may be linear, semi-linear, branched or crosslinked. A linear polyarylene sulfide includes as the main constituting unit the repeating unit of —(Ar—S)—. In general, a linear polyarylene sulfide may include about 80 mol % or more of this repeating unit. A linear polyarylene sulfide may include a small amount of a branching unit or a cross-linking unit, but the amount of branching or cross-linking units may be less than about 1 mol % of the total monomer units of the polyarylene sulfide. A linear polyarylene sulfide polymer may be a random copolymer or a block copolymer containing the above-mentioned repeating unit.

A semi-linear polyarylene sulfide may be utilized that may have a cross-linking structure or a branched structure provided by introducing into the polymer a small amount of one or more monomers having three or more reactive functional groups. For instance between about 1 mol % and about 10 mol % of the polymer may be formed from monomers having three or more reactive functional groups. Methods that may be used in making semi-linear polyarylene sulfide are generally known in the art. By way of example, monomer components used in forming a semi-linear polyarylene sulfide can include an amount of polyhaloaromatic compounds having 2 or more halogen substituents per molecule which can be utilized in preparing branched polymers. Such monomers can be represented by the formula R′Xₙ, where each X is selected from chlorine, bromine, and iodine, n is an integer of 3 to 6, and R′ is a polyvalent aromatic radical of valence n which can have up to about 4 methyl substituents, the total number of carbon atoms in R′ being within the range of 6 to about 16. Examples of some polyhaloaromatic compounds having more than two halogens substituted per molecule that can be employed in forming a semi-linear starting polyarylene sulfide include 1,2,3-trichlorobenzene, 1,2,4-trichlorobenzene, 1,3-dichloro-5-bromobenzene, 1,2,4-triiodobenzene, 1,2,3,5-tetrabromobenzene, hexachlorobenzene, 1,3,5-trichloro-2,4,6-trimethylbenzene, 2,2′,4,4′-tetrachlorobiphenyl, 2,2′,5,5′-tetra-iodobiphenyl, 2,2′,6,6′-tetrabromo-3,3′,5,5′-tetramethylbiphenyl, 1,2,3,4-tetrachloronaphthalene, 1,2,4-tribromo-6-methylnaphthalene, and the like, and mixtures thereof.

Following polymerization, the polyarylene sulfide may be washed with liquid media. For instance, the polyarylene sulfide may be washed with water, acetone, N-methyl-2-pyrrolidone, a salt solution, and/or an acidic media such as acetic acid or hydrochloric acid prior to combination with other components while forming the mixture. The polyarylene sulfide can be washed in a sequential manner that is generally known to persons skilled in the art. Washing with an acidic solution or a salt solution may reduce the sodium, lithium or calcium metal ion end group concentration from about 2000 ppm to about 100 ppm.

The polyarylene sulfide can be subjected to a hot water washing process. The temperature of a hot water wash can be at or above about 100° C., for instance higher than about 120° C., higher than about 150° C., or higher than about 170° C. Generally, distilled water or deionized water can be used for hot water washing. In one embodiment, a hot water wash can be conducted by adding a predetermined amount of the polyarylene sulfide to a predetermined amount of water and heating the mixture under stirring in a pressure vessel. By way of example, a bath ratio of up to about 200 grams of polyarylene sulfide per liter of water can be used. Following the hot water wash, the polyarylene sulfide can be washed several times with warm water, maintained at a temperature of from about 10° C. to about 100° C. A wash can be carried out in an inert atmosphere to avoid deterioration of the polymer.

Organic solvents that will not decompose the polyarylene sulfide can be used for washing the polyarylene sulfide. Organic solvents can include, without limitation, nitrogen-containing polar solvents such as N-methylpyrrolidone, dimethylformamide, dimethylacetamide, 1,3-dimethylimidazolidinone, hexamethylphosphoramide, and piperazinone; sulfoxide and sulfone solvents such as dimethyl sulfoxide, dimethylsulfone, and sulfolane; ketone solvents such as acetone, methyl ethyl ketone, diethyl ketone, and acetophenone, ether solvents such as diethyl ether, dipropyl ether, dioxane, and tetrahydrofuran; halogen-containing hydrocarbon solvents such as chloroform, methylene chloride, ethylene dichloride, trichloroethylene, perchloroethylene, monochloroethane, dichloroethane, tetrachloroethane, perchloroethane, and chlorobenzene; alcohol and phenol solvents such as methanol, ethanol, propanol, butanol, pentanol, ethylene glycol, propylene glycol, phenol, cresol, polyethylene glycol, and polypropylene glycol; and aromatic hydrocarbon solvents such as benzene, toluene, and xylene. Further, solvents can be used alone or as a mixture of two or more thereof.

The polyarylene sulfide can be end functionalized. For instance, a polyarylene sulfide can be further treated following formation with an acid anhydride, amine, isocyanate or functional group-containing modifying compound to provide a functional end group on the polyarylene sulfide. By way of example, a polyarylene sulfide can be reacted with a modifying compound containing a mercapto group or a disulfide group and also containing a reactive functional group. In one embodiment, the polyarylene sulfide can be reacted with the modifying compound in an organic solvent. In another embodiment, the polyarylene sulfide can be reacted with the modifying compound in the molten state.

When forming the polyarylene sulfide, the polymerization reaction apparatus is not especially limited. Examples of a reaction apparatus include a stirring tank type polymerization reaction apparatus having a stirring device that has a variously shaped stirring blade, such as an anchor type, a multistage type, a spiral-ribbon type, a screw shaft type and the like, or a modified shape thereof. Further examples of a reaction apparatus include a mixing apparatus commonly used in kneading, such as a kneader, a roll mill, a Banbury mixer, etc. Following polymerization, the molten polyarylene sulfide may be discharged from the reactor, typically through an extrusion orifice fitted with a die of desired configuration, cooled, and collected. Commonly, the polyarylene sulfide may be discharged through a perforated die to form strands that are taken up in a water bath, and pelletized. The polyarylene sulfide may also be in the form of a strand, granule, or powder. The polyarylene sulfide may be dried, but this is not a requirement.

A polyarylene sulfide polymer or copolymer that is included in a composition (which can also encompass a blend of one or more polyarylene sulfide polymers and/or copolymers) may have any suitable molecular weight. In one embodiment, the polyarylene sulfide can be a low to mid-molecular weight polyarylene sulfide. For instance the polyarylene sulfide may have a number average molecular weight less than about 30,000 g/mol, or less than about 25,000 g/mol, and a weight average molecular weight less than about 65,000 g/mol, or less than about 60,000 g/mol.

The thermoplastic composition can generally include the polyarylene sulfide (or a blend of multiple polyarylene sulfides) in an amount from about 40 wt. % to about 90 wt. % by weight of the composition, for instance from about 45% wt. % to about 80 wt. % by weight of the composition.

Referring again to FIG. 1, the composition can include a molecular sieve that is added following melt of the polyarylene sulfide, e.g., downstream of the main feed throat 114. For instance, the molecular sieve can be added at barrel 124 via feed line 116.

Molecular sieves as may be incorporated in the thermoplastic composition contain pores of a uniform size and can be used as an adsorbent for volatile materials of the thermoplastic composition. For example, the average pore diameter of a molecular sieve can be less than about 15 angstroms, for instance from about 1 to about 15 angstroms, from about 2 to about 13 angstroms, or from about 2 to about 12 angstroms. Without wishing to be bound by any theory, molecules small enough to pass through the pores of the molecular sieve can be adsorbed while larger molecules cannot enter the pores. Molecular sieves can filter and absorb volatiles of the thermoplastic composition on a molecular level. For instance, a water molecule may not be small enough to pass through the molecular sieve while the smaller volatile molecules in the gas phase can be absorbed.

The molecular sieves can include aluminosilicate minerals, clays, porous glasses, microporous charcoals, zeolites, active carbons (activated charcoal or activated carbon), or synthetic compounds that have open structures. In some embodiments, the molecular sieves are an aluminosilicate mineral (e.g., andalusite, kyanite, sillimanite, or mullite). In other embodiments, the molecular sieves can include about 10% or greater of an aluminosilicate, for instance about 50% or greater, about 80% or greater, about 95% or greater, or about 99% or greater (on a weight basis) of an aluminosilicate mineral. In some embodiments, including those embodiments where the molecular sieves comprise an aluminosilicate mineral, the particles of molecular sieves may contain other minerals, such oxides of zirconium or titanium to enhance properties such as strength and wear (e.g., zirconia toughened aluminosilicates or alumina-titanate-mullite composites). In some embodiments the molecular sieves are 3 angstrom molecular sieves, 4 angstrom molecular sieves, 5 angstrom molecular sieves, or angstrom molecular sieves (e.g., type 3A, type 4A, type 5A or type 13X molecular sieves available from Advanced Specialty Gas Equipment). Hardened molecular sieves or those with an especially hard shell, can also be useful in the thermoplastic compositions.

In some embodiments the molecular sieve particles can be greater than about 1 millimeter (mm) in diameter, greater than about 2.0 mm or greater than about 2.5 mm in diameter and less than about 5 mm or less than about 10 mm in diameter. This is not a requirement, however, and in other embodiments the molecular sieve particles can be greater than about 15 mm in diameter or greater than about 20 mm in diameter and less than about 32 mm in diameter or less than about 30 mm in diameter.

In one particular embodiment, the molecular sieve can be a crystalline aluminosilicate. Particular crystalline aluminosilicates can include crystalline aluminosilicate cage structures in which the alumina and silica tetrahedra are intimately connected in an open three dimensional network to form cage-like structures with window-like pores of about 15 angstrom or less free diameter. The tetrahedra are cross-linked by the sharing of oxygen atoms with spaces between the tetrahedra occupied by water molecules prior to partial or total dehydration of this zeolite.

In hydrated form, the crystalline aluminosilicates can include those represented by the formula below:

Mᵣ[(AlO₂)ₛ(SiO₂)ₜ].XH₂O

in which

M is one or more cations that balance the electrovalence of the aluminum-centered tetrahedra and that is generally referred to as an exchangeable cationic site. The generalized cation M may be monovalent, divalent or trivalent or mixtures thereof;

r, s and t are greater than 0; and

X represents the moles of water.

By way of example, an aluminosilicate molecular sieve can be represented by the formula below:

M₁₂-[(AlO₂)₁₂(SiO₂)₁₂].XH₂O

in which

M is potassium, sodium, calcium, or mixtures thereof.

In general, the thermoplastic composition can include the molecular sieve in an amount of less than about 10 wt. % of the thermoplastic composition. For instance, the thermoplastic composition can include the molecular sieve in an amount of from about 1 wt. % to about 8 wt. % or from about 1.5 wt. % to about 6 wt. % of the thermoplastic composition.

According to one embodiment, the molecular sieve can added to the melt processing unit in conjunction with an amount of the polyarylene sulfide. For instance, from about 65% to about 99.5% of the polyarylene sulfide by weight can be added to the main feed throat 114 at barrel 121 and from about 0.5% to about 35% of the polyarylene sulfide by weight can be mixed with the molecular sieve for downstream addition at the feed 116. In this embodiment, that portion of the polyarylene sulfide that is added to the system in conjunction with the molecular sieve can function as a carrier for the molecular sieve. The polyarylene sulfide utilized as a carrier and added downstream in conjunction with the molecular sieve can be the same or different as the polyarylene sulfide added at the main feed throat 114.

Other components of a thermoplastic composition can function as a carrier for the molecular sieve, alternative to or in addition to a portion of the polyarylene sulfide. For instance, the molecular sieve can be added to the composition in conjunction with a colorant, a stabilizer, a lubricant, or the like. Alternatively, the molecular sieve can be injected by itself into the composition within the melt processing unit. When a component of the thermoplastic composition is utilized as a carrier for the molecular sieve, the loading level of the molecular sieve can be from about 0.01% to about 99% by weight of the molecular sieve/carrier mixture.

A boron-nucleating agent can also be employed in the thermoplastic composition to enhance the crystallization properties of the composition. Such nucleating agents typically constitute from about 0.01 wt. % to about 6 wt. %, in some embodiments from about 0.05 wt. % to about 3 wt. %, and in some embodiments, from about 0.1 wt. % to about 2 wt. % of the thermoplastic composition. Suitable boron-containing nucleating agents may include, for instance, boron nitride, sodium tetraborate, potassium tetraborate, calcium tetraborate, etc., as well as mixtures thereof. Boron nitride (BN) has been found to be particularly beneficial. Boron nitride exists in a variety of different crystalline forms (e.g., h-BN—hexagonal, c-BN—cubic or spharlerite, and w-BN—wurtzite), any of which can generally be employed in the present invention. The hexagonal crystalline form is particularly suitable due to its stability and softness.

When included, the boron-containing nucleating agent can be added to the melt at any point, e.g., with the main feed, in conjunction with the polyarylene sulfide, or downstream, for instance in conjunction with the molecular sieve. Besides melt blending, other techniques may also be employed to combine the nucleating agent and the polyarylene sulfide. For example, the nucleating agent may be supplied during one or more stages of the polymerization of the polyarylene sulfide, such as to the polymerization apparatus. Although it may be introduced at any time, it is typically desired to apply the nucleating agent before polymerization has been initiated, and typically in conjunction with the precursor monomers for the polyarylene sulfide. The reaction mixture is generally heated to an elevated temperature within the polymerization reactor vessel to initiate melt polymerization of the reactants.

Regardless of the manner in which they are combined together, the degree and rate of crystallization may be significantly enhanced by the inclusion of a boron-containing nucleating agent in the thermoplastic composition. For example, the crystallization potential of the thermoplastic composition (prior to molding) may be about 52% or more, in some embodiments about 55% or more, in some embodiments about 58% or more, and in some embodiments, from about 60% to about 95%. The crystallization potential may be determined by subtracting the latent heat of crystallization (ΔH_{c}) from the latent heat of fusion (ΔH_{f}), dividing this difference by the latent heat of fusion, and then multiplying by 100. The latent heat of fusion (ΔH_{f}) and latent heat of crystallization (ΔH_{C}) may be determined by Differential Scanning Calorimetry (“DSC”) as is well known in the art and in accordance with ISO Standard 10350. The latent heat of crystallization may, for example, be about 15 Joules per gram (“J/g”) or less, in some embodiments about 12 J/g or less, and in some embodiments, from about 1 to about 10 J/g. The latent heat of fusion may likewise be about 15 Joules per gram (“J/g”) or more, in some embodiments about 18 J/g or more, and in some embodiments, from about 20 to about 28 J/g.

In addition, the thermoplastic composition including the molecular sieve and the boron-containing nucleating agent in conjunction with the polyarylene sulfide may crystallize at a lower temperature than would otherwise occur absent the presence of the nucleating agent. For example, the crystallization temperature (prior to molding) of the thermoplastic composition may about 250° C. or less, in some embodiments from about 100° C. to about 245° C., and in some embodiments, from about 150° C. to about 240° C. The melting temperature of the thermoplastic composition may also range from about 250° C. to about 320° C., and in some embodiments, from about 265° C. to about 300° C. The melting and crystallization temperatures may be determined as is well known in the art using differential scanning calorimetry in accordance with ISO Test No. 11357. Even at such melting temperatures, the ratio of the deflection temperature under load (“DTUL”), a measure of short term heat resistance, to the melting temperature may still remain relatively high. For example, the ratio may range from about 0.65 to about 1.00, in some embodiments from about 0.70 to about 0.99, and in some embodiments, from about 0.80 to about 0.98. The specific DTUL values may, for instance, range from about 230° C. to about 300° C., in some embodiments from about 240° C. to about 290° C., and in some embodiments, from about 250° C. to about 280° C. Such high DTUL values can, among other things, allow the use of high speed processes often employed during the manufacture of components having a small dimensional tolerance.

The thermoplastic composition can also include a coupling agent. The coupling agent can be any coupling agent as is known in the art that includes a silicon, zirconium, titanate, or other multireactive group chemistry. In one embodiment the coupling agent can be an organosilane coupling agent, and in particular may be an alkoxy silane coupling agent as is known in the art including monoalkoxy silanes, dialkoxysilanes, chorlor silanes, and the like. For example, silane coupling agents available from Gelest, Inc. of Morrisville, Pa. can be utilized. The alkoxysilane compound may be a silane compound selected from, and without limitation to, vinlyalkoxysilanes, epoxyalkoxysilanes, aminoalkoxysilanes, mercaptoalkoxysilanes, and combinations thereof. Examples of the vinylalkoxysilane that may be utilized include vinyltriethoxysilane, vinyltrimethoxysilane and vinyltris(3-methoxyethoxy)silane. Examples of the epoxyalkoxysilanes that may be used include □-glycidoxypropyltrimethoxysilane, □-(3,4-epoxycyclohexyl)ethyltrimethoxysilane and □-glycidoxypropyltriethoxysilane. Examples of the mercaptoalkoxysilanes that may be employed include □-mercaptopropyltrimethoxysilane and □-mercaptopropyltriethoxysilane.

Aminosilane coupling agents that may be included in the thermoplastic composition are typically of the formula: R³—Si—(R⁴)₃, wherein R³ is selected from the group consisting of an amino group such as NH₂; an aminoalkyl of from about 1 to about 10 carbon atoms, or from about 2 to about 5 carbon atoms, such as aminomethyl, aminoethyl, aminopropyl, aminobutyl, and so forth; an alkene of from about 2 to about 10 carbon atoms, or from about 2 to about 5 carbon atoms, such as ethylene, propylene, butylene, and so forth; and an alkyne of from about 2 to about 10 carbon atoms, or from about 2 to about 5 carbon atoms, such as ethyne, propyne, butyne and so forth; and wherein R⁴ is an alkoxy group of from about 1 to about 10 atoms, or from about 2 to about 5 carbon atoms, such as methoxy, ethoxy, propoxy, and so forth.

In one embodiment, R³ is selected from the group consisting of aminomethyl, aminoethyl, aminopropyl, ethylene, ethyne, propylene and propyne, and R⁴ is selected from the group consisting of methoxy groups, ethoxy groups, and propoxy groups. In another embodiment, R³ is selected from the group consisting of an alkene of from about 2 to about 10 carbon atoms such as ethylene, propylene, butylene, and so forth, and an alkyne of from about 2 to about 10 carbon atoms such as ethyne, propyne, butyne and so forth, and R⁴ is an alkoxy group of from about 1 to about 10 atoms, such as methoxy group, ethoxy group, propoxy group, and so forth. A combination of various aminosilanes may also be included in the thermoplastic composition.

Some representative examples of amino silane coupling agents that may be included in the thermoplastic composition include aminopropyl triethoxy silane, aminoethyl triethoxy silane, aminopropyl trimethoxy silane, aminoethyl trimethoxy silane, ethylene trimethoxy silane, ethylene triethoxy silane, ethyne trimethoxy silane, ethyne triethoxy silane, aminoethylaminopropyltrimethoxy silane, 3-aminopropyl triethoxy silane, 3-aminopropyl trimethoxy silane, 3-aminopropyl methyl dimethoxysilane or 3-aminopropyl methyl diethoxy silane, N-(2-aminoethyl)-3-aminopropyl trimethoxy silane, N-methyl-3-aminopropyl trimethoxy silane, N-phenyl-3-aminopropyl trimethoxy silane, bis(3-aminopropyl)tetramethoxy silane, bis(3-aminopropyl)tetraethoxy disiloxane, and combinations thereof. The amino silane may also be an aminoalkoxysilane, such as □-aminopropyltrimethoxysilane, □-aminopropyltriethoxysilane, □-aminopropylmethyldimethoxysilane, □-aminopropylmethyldiethoxysilane, N-(□-aminoethyl)-□-aminopropyltrimethoxysilane, N-phenyl-□-aminopropyltrimethoxysilane, □-diallylaminopropyltrimethoxysilane and □-diallylaminopropyltrimethoxysilane. One suitable amino silane is 3-aminopropyltriethoxysilane which is available from Degussa, Sigma Chemical Company, and Aldrich Chemical Company.

The thermoplastic composition may include the coupling agent in an amount from about 0.05 wt. % to about 2 wt. % by weight of the thermoplastic composition, or from about 0.2 wt. % to about 0.8 wt. % by weight of the thermoplastic composition.

As previously stated, when included the coupling agent can be mixed with the polyarylene sulfide prior to addition of the molecular sieve. For instance, and with reference to FIG. 1, the coupling agent can be mixed with the polyarylene sulfide at the main feed 114 of the melt processing unit 100.

In addition to the polyarylene sulfide, a molecular sieve, and (optionally) a coupling agent and/or a boron-containing nucleating agent, one or more fillers can be included in the thermoplastic composition. One or more fillers may generally be included in the thermoplastic composition an amount of from about 5 wt. % to about 70 wt. %, or from about 20 wt. % to about 65 wt. % by weight of the thermoplastic composition.

In the embodiment illustrated in FIG. 1, a filler can added to the melt processor 100 in conjunction with the addition of the molecular sieve at feed line 116. This is not a requirement, however, and the filler can be added separately from the molecular sieve and either upstream of downstream of the point of addition of the molecular sieve. In addition, a filler can be added at a single feed location or may be split and added at multiple feed locations along the extruder. In such as embodiment the molecular sieve can be added prior to all of the multiple filler feeds, in conjunction with the first filler feed, or in conjunction with multiple filler feeds.

In one embodiment, a fibrous filler can be included in the thermoplastic composition. The fibrous filler may include one or more fiber types including, without limitation, polymer fibers, glass fibers, carbon fibers, metal fibers, natural fibers such as jute, bamboo, etc., basalt fibers, and so forth, or a combination of fiber types. In one embodiment, the fibers may be chopped fibers, continuous fibers, or fiber rovings (tows).

A fibrous filler can be glass fiber filler having a low loss on ignition (LOI). A low LOI glass fiber is one in which the weight loss after burning off of organic sizing from the fibers is low. For instance the low LOI fiber can exhibit a weight loss following burning off of organic sizing from the fibers of less than about 8 wt. % as determined according to ASTM D4963, for instance less than about 5 wt. % or less than about 2 wt. %, in one embodiment.

Fiber sizes can vary as is known in the art. In one embodiment, the fibers can have an initial length of from about 3 mm to about 5 mm. In another embodiment, for instance when considering a pultrusion process, the fibers can be continuous fibers. Fiber diameters can vary depending upon the particular fiber used. The fibers, for instance, can have a diameter of less than about 100 □m, such as less than about 50 μm. For instance, the fibers can be chopped or continuous fibers and can have a fiber diameter of from about 5 □m to about 50 □m, such as from about 5 □m to about 15 μm.

The fibers may be pretreated with a sizing as is generally known. In one embodiment, the fibers may have a high yield or small K numbers. The tow is indicated by the yield or K number. For instance, glass fiber tows may have 50 yield and up, for instance from about 115 yield to about 1200 yield.

To further improve the characteristics of the thermoplastic composition, the composition can also include one or more lubricants. Examples of such lubricants include hydrocarbons and hydrocarbon waxes of the type commonly used as lubricants in the processing of engineering plastic materials (e.g., polyolefins and polyolefin waxes), pentaerythritol tetrastearate, calcium stearate, zinc stearate, and mixtures thereof. Hydrocarbon waxes include, without limitation, paraffin waxes, polyolefin and oxidized polyolefin waxes, and microcrystalline waxes.

Exemplary polyolefin lubricants that can be used may include, for instance, polyethylene, polypropylene, blends and copolymers thereof. In one embodiment, a polyethylene lubricant can be utilized that is a copolymer of ethylene and an α-olefin, such as a C3-C20 α-olefin or C3-C12 α-olefin. Specific examples include 1-butene; 3-methyl-1 butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene.

The density of a polyolefin lubricant may vary depending on the type of polymer employed, but generally ranges from 0.85 to 0.96 grams per cubic centimeter (“g/cm³”). Polyethylene “plastomers”, for instance, may have a density in the range of from 0.85 to 0.91 g/cm³. Likewise, “linear low density polyethylene” (“LLDPE”) may have a density in the range of from 0.91 to 0.940 g/cm³; “low density polyethylene” (“LDPE”) may have a density in the range of from 0.910 to 0.940 g/cm³; and “high density polyethylene” (“HDPE”) may have density in the range of from 0.940 to 0.960 g/cm³. Densities may be measured in accordance with ASTM 1505.

Of course, polyolefin lubricants are by no means limited to the use of ethylene polymers. For instance, propylene polymers may also be suitable for use as a lubricant. Suitable propylene polymers may include, for instance, polypropylene homopolymers, as well as copolymers or terpolymers of propylene with an α-olefin (e.g., C3-C20), such as ethylene, 1-butene, 2-butene, the various pentene isomers, 1-hexene, 1-octene, 1-nonene, 1-decene, 1-unidecene, 1-dodecene, 4-methyl-1-pentene, 4-methyl-1-hexene, 5-methyl-1-hexene, vinylcyclohexene, styrene, etc.

When employed, the lubricant(s) typically constitute up to about 1.0% by weight, and in some embodiments, from about 0.1% by weight to about 0.5% by weight of the thermoplastic composition. In one embodiment, the lubricant can be employed in greater amounts than considered necessary in the past.

In general, a lubricant can be combined with the polyarylene sulfide and added to the extruder 100 at the main feed throat 14 as illustrated in FIG. 1, however, this is not a requirement of the formation process.

One suitable additive that may be employed to improve the mechanical properties of the composition is an impact modifier. Examples of suitable impact modifiers may include, for instance, polyepoxides, polyurethanes, polybutadiene, acrylonitrile-butadiene-styrene, polysiloxanes etc., as well as mixtures thereof. In one particular embodiment, a polyepoxide modifier is employed that contains at least two oxirane rings per molecule. The polyepoxide may be a linear or branched, homopolymer or copolymer (e.g., random, graft, block, etc.) containing terminal epoxy groups, skeletal oxirane units, and/or pendent epoxy groups. The monomers employed to form such polyepoxides may vary. In one particular embodiment, for example, the polyepoxide modifier contains at least one epoxy-functional (meth)acrylic monomeric component. The term “(meth)acrylic” includes acrylic and methacrylic monomers, as well as salts or esters thereof, such as acrylate and methacrylate monomers. Suitable epoxy-functional (meth)acrylic monomers may include, but are not limited to, those containing 1,2-epoxy groups, such as glycidyl acrylate and glycidyl methacrylate. Other suitable epoxy-functional monomers include allyl glycidyl ether, glycidyl ethacrylate, and glycidyl itoconate.

If desired, additional monomers may also be employed in the polyepoxide to help achieve the desired melt viscosity. Such monomers may vary and include, for example, ester monomers, (meth)acrylic monomers, olefin monomers, amide monomers, etc. In one particular embodiment, for example, the polyepoxide modifier includes at least one linear or branched α-olefin monomer, such as those having from 2 to 20 carbon atoms and preferably from 2 to 8 carbon atoms. Specific examples include ethylene, propylene, 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are ethylene and propylene. In one particularly desirable embodiment of the present invention, the polyepoxide modifier is a copolymer formed from an epoxy-functional (meth)acrylic monomeric component and α-olefin monomeric component. For example, the polyepoxide modifier may be poly(ethylene-co-glycidyl methacrylate). One specific example of a suitable polyepoxide modifier that may be used in the present invention is commercially available from Arkema under the name Lotader AX8840. Lotader AX8950 has a melt flow rate of 5 g/10 min and has a glycidyl methacrylate monomer content of 8 wt. %.

Still another additive that may be employed in the thermoplastic composition is a disulfide compound. Without wishing to be bound by any particular theory, the disulfide compound can undergo a polymer scission reaction with a polyarylene sulfide during melt processing that even further lowers the overall melt viscosity of the composition. When employed, disulfide compounds typically constitute from about 0.01 wt. % to about 3 wt. %, in some embodiments from about 0.02 wt. % to about 1 wt. %, and in some embodiments, from about 0.05 to about 0.5 wt. % of the composition. The ratio of the amount of the polyarylene sulfide to the amount of the disulfide compound may likewise be from about 1000:1 to about 10:1, from about 500:1 to about 20:1, or from about 400:1 to about 30:1. Suitable disulfide compounds are typically those having the following formula:

R³—S—S—R⁴

wherein R³ and R⁴ may be the same or different and are hydrocarbon groups that independently include from 1 to about 20 carbons. For instance, R³ and R⁴ may be an alkyl, cycloalkyl, aryl, or heterocyclic group. In certain embodiments, R³ and R⁴ are generally nonreactive functionalities, such as phenyl, naphthyl, ethyl, methyl, propyl, etc. Examples of such compounds include diphenyl disulfide, naphthyl disulfide, dimethyl disulfide, diethyl disulfide, and dipropyl disulfide. R³ and R⁴ may also include reactive functionality at terminal end(s) of the disulfide compound. For example, at least one of R³ and R⁴ may include a terminal carboxyl group, hydroxyl group, a substituted or non-substituted amino group, a nitro group, or the like. Examples of compounds may include, without limitation, 2,2′-diaminodiphenyl disulfide, 3,3′-diaminodiphenyl disulfide, 4,4′-diaminodiphenyl disulfide, dibenzyl disulfide, dithiosalicyclic acid, dithioglycolic acid, α,α′-dithiodilactic acid, β,β′-dithiodilactic acid, 3,3′-dithiodipyridine, 4,4′dithiomorpholine, 2,2′-dithiobis(benzothiazole), 2,2′-dithiobis(benzimidazole), 2,2′-dithiobis(benzoxazole) and 2-(4′-morpholinodithio)benzothiazole.

Still other additives that can be included in the thermoplastic composition can encompass, without limitation, antimicrobials, pigments or other colorants, impact modifiers, antioxidants, stabilizers, surfactants, flow promoters, solid solvents, and other materials added to enhance properties and processability. Such optional materials may be employed in the thermoplastic composition in conventional amounts and according to conventional processing techniques, for instance through addition in conjunction with the polyarylene sulfide at the main feed throat.

Following addition of all components to the thermoplastic composition, the composition is thoroughly mixed in the remaining section(s) of the extruder and extruded through a die. The final extrudate can be pelletized or other wise shaped as desired, for instance the final extrudate can be in the form of a pultruded shape.

Conventional shaping processes for forming articles out of a melt processed thermoplastic composition include, without limitation, extrusion, injection molding, blow-molding, thermoforming, foaming, compression molding, hot-stamping, pultrusion, and so forth.

In one embodiment, the thermoplastic composition may be processed according to an injection molding process. This method includes the injection of the thermoplastic composition into a mold cavity where it is cooled until reaching the desired ejection temperature. As discussed above, in one embodiment, the cooling time and/or mold temperature of a molding cycle can be substantially reduced while still achieving the same degree of crystallization. In addition to improving the properties of the cooling cycle, other aspects of the molding operation may also be enhanced. For example, as is known in the art, injection can occur in two main phases—i.e., an injection phase and holding phase. During the injection phase, the mold cavity is completely filled with the molten thermoplastic composition. The holding phase is initiated after completion of the injection phase in which the holding pressure is controlled to pack additional material into the cavity and compensate for volumetric shrinkage that occurs during cooling. After the shot has built, it can then be cooled. In addition to reducing the cooling time, the properties of the thermoplastic composition may also allow for a lower holding time, which includes the time required to pack additional material into the cavity and the time at which this material is held at a certain pressure. Once cooling is complete, the molding cycle is completed when the mold opens and the part is ejected, such as with the assistance of ejector pins within the mold.

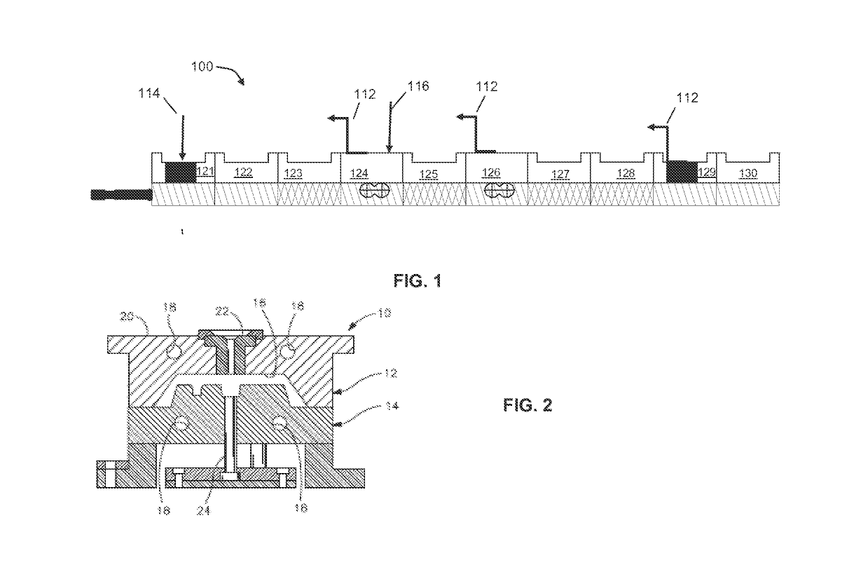

Any suitable injection molding equipment may generally be employed in the present invention. Referring to FIG. 2, for example, one embodiment of an injection molding apparatus or tool 10 that may be employed in the present invention is shown. In this embodiment, the apparatus 10 includes a first mold base 12 and a second mold base 14, which together define an article or component-defining mold cavity 16. The molding apparatus 10 also includes a resin flow path that extends from an outer exterior surface 20 of the first mold half 12 through a sprue 22 to a mold cavity 16. The resin flow path may also include a runner and a gate, both of which are not shown for purposes of simplicity. The thermoplastic composition may be supplied to the resin flow path using a variety of techniques. For example, the thermoplastic composition may be supplied (e.g., in the form of pellets) to a feed hopper attached to an extruder barrel that contains a rotating screw (not shown). As the screw rotates, the pellets are moved forward and undergo pressure and friction, which generates heat to melt the pellets. Additional heat may also be supplied to the composition by a heating medium that is communication with the extruder barrel. One or more ejector pins 24 may also be employed that are slidably secured within the second mold half 14 to define the mold cavity 16 in the closed position of the apparatus 10. The ejector pins 24 operate in a well-known fashion to remove a molded part from the cavity 16 in the open position of the molding apparatus 10.

A cooling mechanism may also be provided to solidify the resin within the mold cavity. In FIG. 2, for instance, the mold bases 12 and 14 each include one or more cooling lines 18 through which a cooling medium flows to impart the desired mold temperature to the surface of the mold bases for solidifying the molten material. As noted above, the present inventors have found that the improved crystallization properties of the thermoplastic composition can allow it to be molded at lower mold temperatures than previously thought possible. In addition to minimizing the energy requirements for the molding operation, such lower mold temperatures may also be achieved using mechanisms that are less corrosive and expensive than some conventional techniques. For example, liquid water may be employed as the cooling medium and may be heated to a temperature within the ranges noted above.

Shaped articles that may be formed may include structural and non-structural shaped parts, for instance for appliances, electrical materials, electronic products, and automotive engineering thermoplastic assemblies. Exemplary automotive shaped plastic parts are suitable for under the hood applications, including fan shrouds, supporting members, covers, housings, battery pans, battery cases, ducting, electrical housings, fuse buss housings, and blow-molded containers, to name a few. Other useful articles besides moldings, and extrusion products include wall panels, overhead storage lockers, serving trays, seat backs, cabin partitions, window covers, and electronic packaging handling systems such as integrated circuit trays.

The thermoplastic composition can be readily formed into parts having a wide range of different parts. The parts may be in the form of a substrate having an average thickness of about 25 millimeters or less, in some embodiments from about 0.5 to about 15 millimeters, and in some embodiments, from about 1 millimeter to about 10 millimeters. Alternatively, the part may simply possess certain features (e.g., walls, ridges, etc.) within the average thickness ranges noted above.

One particular component that may incorporate a molded part of the thermoplastic composition is a liquid pump (e.g., water pump). The liquid pump may be a direct lift pump, positive displacement pump (e.g., rotary, reciprocating, or linear), rotodynamic pump (e.g., centrifugal), gravity pump, etc. Rotodynamic pumps, in which energy is continuously imparted to the pumped fluid by a rotating impeller, propeller, or rotor, are particularly suitable. In a centrifugal pump, for instance, fluid enters a pump impeller along or near to the rotating axis and is accelerated by the impeller, flowing radially outward into a diffuser or volute chamber, from which it exits into the downstream piping. Such pumps are often used in automotive applications to move a coolant through the engine. Due to the high temperatures associated with automotive engines, the injection molded composition of the present invention is particularly well suited for use in the centrifugal pumps of such automotive cooling systems. In certain embodiments, for example, all or a portion (e.g., blades) of the water impeller may be formed from the injection molded composition of the present invention. Centrifugal pumps also generally include a housing that encloses certain components of the pump and protects them from heat, corrosion, etc. In some embodiments, some or all of the housing may be formed from the injection molded composition of the present invention.

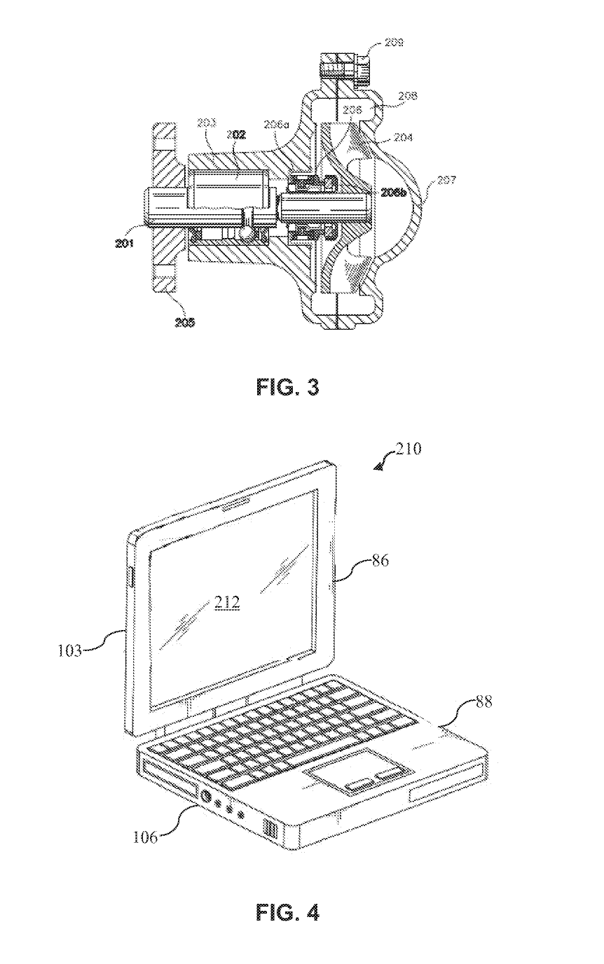

Referring to FIG. 3, one particular example of a centrifugal pump is shown that can employ the injection molded composition of the present invention. In the illustrated embodiment, the pump contains a rotary shaft 201 supported on a housing 203 via a bearing 202. A pump impeller 204, which may contain the injection molded composition of the present invention, is rigidly fixed at an end of the rotary shaft 201. A pulley hub 205 is also rigidly fixed on the base end portion of the rotary shaft 201. Between the bearing 202 and the pump impeller 204, a mechanical seal 206 is formed that is constituted by a stationary member 206a fixed on the side of the housing 203 and a rotary member 206b fixedly engaged with the rotary shaft 201. The pump may also include a housing 207, which can contain the injection molded composition of the present invention. The housing 207 may be affixed to the pump housing 203 (e.g., with fastening bolts) so that a volute chamber 208 is defined therebetween. While not illustrated, a suction portion and a discharge port may also be provided within the housing 207.

Of course, the injection molded composition is not limited to the formation of water pumps or portions thereof, and it may be utilized in forming all manner of components. In one embodiment, the melt processed thermoplastic composition can be used in a variety of electrical and electronics applications. For instance, utilization of a melt processed thermoplastic composition in the formation of overmolding (insert-molding) parts is encompassed.

The melt processed thermoplastic compositions are useful to form an overmolding that includes a coating of the melt processed thermoplastic composition on a metal body. The metal body may be any one of various metal bases or a metal base with an undercoat formed in advance with an inorganic material and/or an organic material.

The metal base material can include, without limitation, aluminum, iron, titanium, chromium, nickel, and alloys containing at least one of these metals, for example, duralumin, carbon steel and stainless steel can provide heat resistance, corrosion resistance, adhesion properties, mechanical characteristics, economy and the like.

The overmolding can be formed by providing at least one coating layer of a melt processed thermoplastic composition on a metal base. By way of example, the coating process can include a pretreatment of a metal base that is carried out prior to the formation of the coating layer. A pretreatment can improve adhesion between the metal base and the coating layer. Pretreatment generally includes cleaning, surface roughening or surface modification, or a combination thereof.

Cleaning can be carried out with a detergent, a solvent, an acid or an alkali, or a removal treatment of rust or burrs with a derusting agent, by a physical method (sand blasting, honing or the like) or a high-temperature heating treatment. Surface roughening can be, e.g., a chemical roughening treatment with an oxidizing agent, electrolytic oxidation or a physical method such as sand blasting. Surface modification can improve the adhesion of the metal base to the coating layer. It can be include a surface oxidation treatment (e.g., with an oxidizing agent, or by electrolytic oxidation or high-temperature oxidation), a surface-nitriding treatment, or a surface-hydroxylating treatment (by steaming).

Optionally, an undercoat may be applied, for instance to reduce the difference in the coefficient of linear expansion between the metal base and the coating layer, to improve the adhesion between the metal base and the coating layer, and to prevent corrosion of the metal base upon its coating treatment. When included, an undercoat may include inorganic material layers such as ceramic layers, glass layers and cermet layers as well as layers of the same kind as the coating layer or of a kind different from the coating layer. Methods for coating may include, without limitation, slurry coating, powder coating, fluidized bed coating and electrostatic coating.

Following pretreatment and formation of any undercoat layer(s), a melt processed thermoplastic composition can be coated on the metal base to form a coating layer. The coating layer can be formed according to any standard coating method as is generally known in the art including, without limitation, slurry coating, powder coating, fluidized bed coating and electrostatic coating.

Depending on the application purpose of the overmolding, a coating layer of a kind different from the layer of the melt processed thermoplastic composition and any undercoat may be applied additionally as an intermediate coating layer or a topcoat. For instance, a topcoat of a fluoroplastic or fluorinated polymer composition can be formed on the melt processed thermoplastic composition coating layer.

An overmolding may be used in a wide variety of applications, such as components for automobiles, trucks, commercial airplanes, aerospace, rail, household appliances, computer hardware, hand held devices, recreation and sports, structural component for machines, structural components for buildings, etc.

Wireless electronic devices are particularly suitable for incorporation of a melt processed thermoplastic composition as disclosed herein. For example, the overmolding may serve as a housing for a wireless electronic device. In such embodiments, an antenna may be disposed on and/or within the metal component prior to overmolding. The metallic component itself may also be used as part of the antenna. For example, portions of the metal component may be shorted together to form a ground plane in or to expand a ground plane structure that is formed from a planar circuit structure, such as a printed circuit board structure (e.g., a printer circuit board structure used in forming antenna structures). Alternatively, the antenna may also be embedded within the melt processed thermoplastic composition during the molding process. Other discrete components can also be embedded within the melt processed thermoplastic composition, such as metal stampings, bushings, electromechanical parts, filtration materials, metal reinforcement and other discrete parts that are combined into a single unitary component through the injection of thermoplastic around the carefully placed parts.

Examples of suitable wireless electronic devices may include a desktop computer or other computer equipment, a portable electronic device, such as a laptop computer or small portable computer of the type that is sometimes referred to as “tablets.” In one suitable arrangement, the portable electronic device may be a handheld electronic device. Examples of portable and handheld electronic devices may include cellular telephones, media players with wireless communications capabilities, handheld computers (also sometimes called personal digital assistants), remote controls, global positioning system (“GPS”) devices, and handheld gaming devices. The device may also be a hybrid device that combines the functionality of multiple conventional devices. Examples of hybrid devices include a cellular telephone that includes media player functionality, a gaming device that includes a wireless communications capability, a cellular telephone that includes game and email functions, and a handheld device that receives email, supports mobile telephone calls, has music player functionality and supports web browsing.

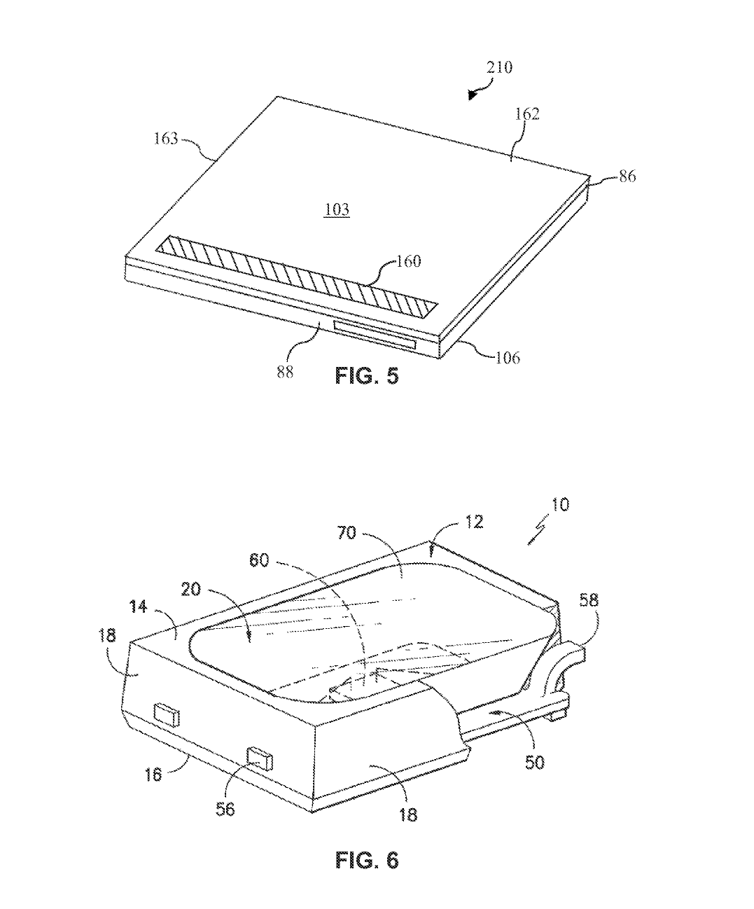

Referring to FIGS. 4-5, one particular embodiment of a wireless electronic device 100 is shown as a laptop computer. The electronic device 210 includes a display member 103 rotatably coupled to a base member 106. The display member 103 may be a liquid crystal diode (LCD) display, an organic light emitting diode (OLED) display, a plasma display, or any other suitable display. The display member 103 and the base member 106 each contain a housing 86 and 88, respectively, for protecting and/or supporting one or more components of the electronic device 210. The housing 86 may, for example, support a display screen 212 and the base member 106 may include cavities and interfaces for various user interface components (e.g. keyboard, mouse, and connections to other peripheral devices).

The overmolding may generally be employed to form any portion of the electronic device 210. In most embodiments, however, the overmolding is employed to form all or a portion of the housing 86 and/or 88. For example, the housing 86 shown in FIG. 5 is formed from the overmolding and contains a melt processed thermoplastic composition 160 adhered to an interior surface (not shown) of a metal component 162. In this particular embodiment, the melt processed thermoplastic composition 160 is in the form of a strip, which may optionally cover an antenna (not shown) located in the housing 86. Of course, the antenna and/or melt processed thermoplastic composition 160 may be disposed at other location of the housing 86, such as adjacent to a corner, along an edge, or in any other suitable position. Regardless, the resulting overmolding formed with the melt processed thermoplastic composition 160 and the metal component 162 defines an exterior surface 163 of the housing 86.

Although not expressly shown, the device 210 may also contain circuitry as is known in the art, such as storage, processing circuitry, and input-output components. Wireless transceiver circuitry in circuitry may be used to transmit and receive radio-frequency (RF) signals. Communications paths such as coaxial communications paths and microstrip communications paths may be used to convey radio-frequency signals between transceiver circuitry and antenna structures. A communications path may be used to convey signals between the antenna structure and circuitry. The communications path may be, for example, a coaxial cable that is connected between an RF transceiver (sometimes called a radio) and a multiband antenna.

FIG. 6 illustrates an enclosed housing 10 that may enclose a light source, for instance a light emitting diode 60. The housing 10 includes a reflector 12. As shown, the reflector 12 has a top 14 and a bottom 16. Side walls 18, extend from the top 14 to the bottom 16 and can be connected together to form a periphery of the housing 10. Each side wall 18 may be linear, curvilinear, and/or have any suitable side wall portions at any suitable angles relative to other portions. The side walls 18 have a depth sufficient for a light source 60, such as an LED, to be recessed within the housing 10. In general, the housing 10 may have any suitable shape. For instance, the housing 10 may be cylindrical, conical, parabolic, or any other suitable curved form. Additionally or alternatively, the walls 18 of the housing may be parallel, substantially parallel, or tapered. Thus, it should be understood that the housing 10 may include any suitable number of walls, each wall having any suitable shape and/or orientation.

The housing also includes a top 20 that abuts the top 14 of the reflector 12. Top 20 can be formed of a transparent or translucent material 70 such as a glass or transparent polymeric material such that the top 20 can act as a lens or window for light being emitted from the light source 60. The housing 10 can also include a frame assembly 50 for mounting the housing, for instance in an automobile and electrodes 56, 58.

In one embodiment, the walls 18 may have smooth surfaces, thus defining a smooth inner surface of the reflector 12, or may have any suitable surface texture. At least one of the side walls 18 may have a reflective inner surface. It should be understood that any suitable number of side walls having any shape and/or orientation may be reflective side walls.

At least a portion of the walls 18 and bottom 16 of the reflector 12 can be formed of the thermoplastic composition. The reduced volatility of the thermoplastic composition can prevent volatiles to be released from the thermoplastic composition and as such can prevent materials from collecting on the transparent or translucent material 70 of the top 20. The ‘fogging’ of a transparent section of a device due to volatile release from surrounding polymeric compositions has in the past led to lower function and even a dangerous situation arising from continued use of the devices.

Other products that can beneficially incorporate the thermoplastic composition can include products that can be used in high temperature operations such as, for example, cooking. For instance, the thermoplastic composition can be used in forming microwave ovens (e.g., walls, racks, etc.), ovens, or range tops (for instance vent housings, burner trim, etc.). The reduced volatility of the thermoplastic composition can also be beneficial during formation of products such as electronics and medical equipment that often must be processed under high temperature for thermal curing of portions of the device and/or thermal advancing (e.g., curing an adhesive) of the device. Due to the nature of the product, these formation steps must often be carried out in a clean environment. Through inclusion of the thermoplastic composition as a component of such devices, volatiles during processing can be reduced, which can improve working conditions for individuals during formation as well as prevent deposition of the volatiles and the associated contamination of surfaces that can come about with previously known, more volatile thermoplastic compositions.

Embodiments of the present disclosure are illustrated by the following examples that are merely for the purpose of illustration of embodiments and are not to be regarded as limiting the scope of the invention or the manner in which it may be practiced. Unless specifically indicated otherwise, parts and percentages are given by weight.

### Test Methods and Sample Components

### Test Methods

Melt Viscosity:

All materials are dried for 1.5 hours at 150° C. under vacuum prior to testing. The melt viscosity is measured on a capillary rheometer at 316° C. and 400 sec⁻¹ with the viscosity measurement taken after five minutes of constant shear.

Tensile Properties:

Tensile properties are tested according to ISO Test No. 527 (technically equivalent to ASTM D638). Modulus and strength measurements are made on the same test strip sample having a length of 80 mm, thickness of 10 mm, and width of 4 mm. The testing temperature is 23° C., and the testing speeds are 1 or 5 mm/min.

Deflection Temperature Under Load (“DTUL”):

The deflection under load temperature was determined in accordance with ISO Test No. 75-2 (technically equivalent to ASTM D648-07). A test strip sample having a length of 80 mm, thickness of 10 mm, and width of 4 mm was subjected to an edgewise three-point bending test in which the specified load (maximum outer fibers stress) was 1.8 MPa. The specimen was lowered into a silicone oil bath where the temperature is raised at 2° C. per minute until it deflects 0.25 mm (0.32 mm for ISO Test No. 75-2).

Izod Notched Impact Strength:

Notched Izod properties were tested according to ISO Test No. 80 (technically equivalent to ASTM D256). This test was run using a Type A notch. Specimens were cut from the center of a multi-purpose bar using a single tooth milling machine. Testing temperature was 23° C.

Volatility:

Volatility of a thermoplastic composition was analyzed by first heating a sample in a sealed chamber at 230° C. for 4 hours to encourage any volatiles in the sample to pass into the gas phase. Following, the volatiles were transferred to a gas chromatograph for quantitative analysis. The gas chromatograph obtained was integrated to determine the total area under the peaks, and this result was utilized to determine overall volatility of the sample with the units of the determination therefore being arbitrary. A standard curve using acetone as a model compound was developed that exhibited a linear responsibility in which y=1.3989x−0.0224 (y=peak area, x=concentration of volatiles and R²=0.9999)

### Sample Components

### Polyphenylene Sulfide Resins:

PPS-A—low melt viscosity Fortron® polyphenylene sulfide available from Ticona Engineering Polymers

PPS-B—high melt viscosity Fortron® polyphenylene sulfide available from Ticona Engineering Polymers

### Molecular Sieve

MS-A—a metal aluminumsilicate molecular sieve having a nominal pore diameter of 4 angstroms

MS-B—a metal aluminumsilicate molecular sieve having a nominal pore diameter of 10 angstroms.

### Coupling Agent:

APTES—3-aminopropyltriethoxysilane—KBE-903 available from Shin-Etsu Silicone

### Lubricants:

LUB-A—Glycolube® P—a pentaerythritol tetrastearate from Lonza, Inc.

LUB-B—Licowax® PE 190—a high molecular weight polyethylene wax available from Clariant Waxes

### Fillers:

Fiber-A—10 □m diameter fiberglass available from OCV™ Reinforcements

Fiber-B—low loss on ignition fiberglass available from OCV™

### Reinforcements

Particulate A—Hubercarb® G3 calcium carbonate available from Huber Engineered Materials

Particulate B—15-15 Vicron® calcium carbonate available from Specialty Minerals

### Colorant:

black colorant—Fortron® 1100 SD3002

### Example 1

Samples were formed as described in the Table below:

| | Comparative | Inventive | Inventive |
|---|---|---|---|
| | Sample 1 | Sample 1 | Sample 2 |
| PPS-B | 56.8 | 53.9 | 51.9 |
| Fiber-A | 40 | — | — |
| Fiber-B | — | 40 | 40 |
| Coupling Agent | 0.4 | 0.4 | 0.4 |
| LUB-A | 0.3 | — | — |
| LUB-B | — | 0.2 | 0.2 |
| Colorant | 2.5 | 2.5 | 2.5 |
| MS-A | — | 3 | 5 |

The product compositions were then tested for a variety of physical characteristics. Results are provided in the table below.

| | Comparative | Inventive | Inventive |
|---|---|---|---|
| | Sample 1 | Sample 1 | Sample 2 |
| Volatility | 44.92 | 44.1 | 24.46 |
| Tensile strength at break | 195 | 202 | 199 |
| (MPa) | | | |
| Tensile elongation at yield (%) | 1.9 | 1.9 | 1.8 |
| DTUL @ 1.8 MPa | 270 | 269 | 270 |
| Notched Izod (kj/m²) | 10 | 8 | 8.2 |

As can be seen the addition of the molecular sieve to the formulation reduced the volatility of the samples. For Inventive Sample 2 the molecular sieve was added downstream of the aminosilane, leading to significant reduction in volatiles. For Inventive Sample 1 all components save the glass fiber was fed to the main feed of an extruder. Thus, the coupling agent and the molecular sieve were mixed at feed. For Inventive Sample 2, the molecular sieve was mixed with a small amount of the polyphenylene sulfide and added downstream of the aminosilane. The glass fiber of Inventive Sample 2 was added downstream of the molecular sieve addition.

### Example 2

Samples were formed as described in the Table below:

| | Comp. | Comp. | Comp. | Inv. | Inv. | Inv. | Inv. | Inv. | Inv. | Inv. | Inv. |
|---|---|---|---|---|---|---|---|---|---|---|---|
| | 3 | 4 | 5 | 3 | 4 | 5 | 6 | 7 | 8 | 9 | 10 |
| PPS-A | 32.45 | 32.65 | 32.65 | 31.15 | 32.65 | 31.15 | — | — | — | — | 31.15 |
| PPS-B | — | — | — | — | — | — | 31.15 | 31.15 | 31.15 | 31.15 | — |
| Fiber-A | 33 | — | — | — | — | 20 | 20 | — | — | — | — |
| Fiber-B | — | 20 | 20 | 20 | 20 | — | — | 20 | 20 | 20 | 20 |
| Particulate | 33 | 46 | 48 | 44.5 | 44.5 | 44.5 | 44.5 | 44.5 | 44.5 | 44.5 | 44.5 |
| A | | | | | | | | | | | |
| LUB-A | 0.3 | — | — | — | — | — | — | — | — | — | — |
| LUB-B | — | 0.1 | 0.1 | 0.1 | 0.1 | 0.1 | 0.1 | 0.1 | 0.1 | 0.1 | 0.1 |
| MS-A | — | — | — | 3 | 1.5 | 3 | 3 | 3 | — | 3 | 3 |
| MS-B | — | — | — | — | — | — | — | — | 3 | — | — |
| Colorant | 1.25 | 1.25 | 1.25 | 1.25 | 1.25 | 1.25 | 1.25 | 1.25 | 1.25 | 1.25 | 1.25 |

The product compositions were then tested for a variety of physical characteristics. Results are provided in the table below.

| | Comp. | Comp. | Comp. | Inv. | Inv. | Inv. | Inv. | Inv. | Inv. | Inv. | Inv. |
|---|---|---|---|---|---|---|---|---|---|---|---|
| | 3 | 4 | 5 | 3 | 4 | 5 | 6 | 7 | 8 | 9 | 10 |
| Volatility | 30.6 | 29.15 | 25.15 | 14.35 | 18.07 | 12.83 | 12.75 | 9.75 | 17.82 | 12.00 | 13.73 |
| Melt Viscosity | 2.92 | 3.4 | 3.257 | 4.498 | 3.636 | 4.483 | 6.57 | 7.23 | 8.3 | 7.3 | 4.26 |
| (kilopoise) | | | | | | | | | | | |
| Tensile strength at | 130.6 | 104.3 | 116.75 | 128.28 | 128.5 | 133.87 | 131.52 | 126.63 | 121.18 | 126.99 | 126.6 |
| break (MPa) | | | | | | | | | | | |
| Tensile elongation | 0.88 | 0.71 | 0.8 | 0.9 | 0.93 | 0.99 | 1.09 | 0.96 | 0.91 | 0.92 | 0.93 |
| at yield (%) | | | | | | | | | | | |
| DTUL @ 1.8 MPa (° C.) | 273.3 | 271 | 275.3 | 274.9 | 274.7 | 273.8 | 272.6 | 269 | 266.2 | 268.6 | 273.3 |
| Notched Izod | 7.4 | 5.2 | 5.8 | 6.5 | 6.5 | 7 | 6.2 | 5.6 | 7.3 | 8.2 | 5.1 |
| (kj/m²) | | | | | | | | | | | |
| Recrystallization | — | — | — | — | — | — | — | — | — | — | 228.95 |
| Temp (° C.) | | | | | | | | | | | |

As can be seen the addition of the molecular sieve led to a significant drop in volatiles of the compositions without loss of other characteristics of the composition.

### Example 3

A sample was formed as described in the Table below:

| | Inv. 11 |
|---|---|
| PPS-B | 31.00 |
| Fiber-B | 20.00 |
| Particulate B | 44.50 |
| LUB-B | 0.10 |
| MS-A | 3.00 |
| Boron Nitride | 0.15 |
| Color Concentrate | 1.25 |

The product composition was then tested for a variety of physical characteristics. Results are provided in the table below.

| | Inv. 11 |
|---|---|
| Volatility | 13.08 |
| Melt Viscosity (kilopoise) | 4.4 |
| Tensile strength at break (MPa) | 115.6 |
| Tensile elongation at yield (%) | 0.74 |
| DTUL @ 1.8 MPa (° C.) | 275.6 |
| Notched Izod (kj/m²) | 6.2 |
| Recrystallization Temp (° C.) | 249.02 |

While certain representative embodiments and details have been shown for the purpose of illustrating the subject invention, it will be apparent to those skilled in this art that various changes and modifications may be made therein without departing from the scope of the subject invention.

What is claimed is:

1. A thermoplastic composition comprising a polyarylene sulfide and a molecular sieve, the molecular sieve having an average pore diameter of less than about 15 angstroms.

2. The thermoplastic composition of claim 1, the thermoplastic composition exhibiting a volatility of less than about 25 as determined by gas chromatography following heat treatment of the thermoplastic composition at 230° C. for 4 hours.

3. The thermoplastic composition of claim 1, the thermoplastic composition having a tensile strength at break of greater than about 100 megapascals as determined according to ISO Test No. 527 at a temperature of 23° C. and a test speed of 5 mm/min.

4. The thermoplastic composition of claim 1, the thermoplastic composition having a tensile elongation at yield that is about ±5% of the tensile elongation at yield of a second thermoplastic composition that differs from the thermoplastic composition only by the presence of the molecular sieve in the thermoplastic composition.

5. The thermoplastic composition of claim 1, the thermoplastic composition having a deflection temperature under load that is about ±5% of the deflection temperature under load of a second thermoplastic composition that differs from the thermoplastic composition only by the presence of the molecular sieve in the thermoplastic composition.

6. The thermoplastic composition of claim 1, the thermoplastic composition having an Izod notched impact strength that is about ±5% of the Izod notched impact strength of a second thermoplastic composition that differs from the thermoplastic composition only by the presence of the molecular sieve in the thermoplastic composition.

7. The thermoplastic composition of claim 1, wherein the polyarylene sulfide is a polypropylene sulfide.

8. The thermoplastic composition of claim 7, wherein the polypropylene sulfide is a linear polypropylene sulfide.

9. The thermoplastic composition of claim 1, wherein the thermoplastic composition includes the polyarylene sulfide in an amount of from about 40 wt. % to about 90 wt. % of the thermoplastic composition.

10. The thermoplastic composition of claim 1, wherein the molecular sieve has an average pore size of from about 2 to about 13 angstroms.

11. The thermoplastic composition of claim 1, wherein the molecular sieve is an aluminosilicate.

12. The thermoplastic composition of claim 1, wherein the molecular sieve has a structure represented by the formula:
Mᵣ[(AlO₂)ₛ(SiO₂)ₜ].XH₂O
in which
M is one or more cations that balance the electrovalence of the aluminum-centered tetrahedra and that is monovalent, divalent or trivalent or mixtures thereof;
r, s and t are greater than 0; and
X represents the moles of water.

13. The thermoplastic composition of claim 12, wherein the molecular sieve has a structure represented by the formula:
M₁₂-[(AlO₂)₁₂(SiO₂)₁₂]*XH₂O
in which M is potassium, sodium, calcium, or mixtures thereof.

14. The thermoplastic composition of claim 1, the thermoplastic composition including the molecular sieve in an amount of less than about 10 wt. % of the thermoplastic composition.

15. The thermoplastic composition of claim 1, further comprising a coupling agent.

16. The thermoplastic composition of claim 15, wherein the coupling agent is an aminosilane coupling agent.

17. The thermoplastic composition of claim 15, wherein the thermoplastic composition includes the coupling agent in an amount from about 0.05 wt. % to about 2 wt. % by weight of the thermoplastic composition.

18. The thermoplastic composition of claim 1, further comprising one or more fillers.

19. The thermoplastic composition of claim 18, wherein the fillers comprise fibrous fillers or particulate fillers.

20. The thermoplastic composition according to claim 19, wherein the fibrous filler comprises glass fibers, polymer fibers, carbon fibers, metal fibers, or a combination thereof.

21. The thermoplastic composition of claim 19, wherein the fillers comprise low loss on ignition fibers.

22. The thermoplastic composition of claim 1, further comprising one or more lubricants.

23. The thermoplastic composition of claim 1, further comprising a boron-containing nucleating agent.

24. An overmolding comprising the thermoplastic composition according to claim 1.

25. The overmolding of claim 24, wherein the overmolding is a component of an electronic device.

26. A method for forming a thermoplastic composition comprising:
feeding a polyarylene sulfide to a melt processing unit;
feeding a molecular sieve to the melt processing unit, the molecular sieve being fed to the melt processing unit following melting of the polyarylene sulfide in the melt processing unit, the molecular sieve having an average pore diameter of less than about 15 angstroms.

27. The method of claim 26, further comprising feeding a coupling agent to the melt processing unit, the coupling agent being fed to the melt processing unit prior to feeding the molecular sieve to the melt processing unit.

28. The method of claim 26, further comprising forming the thermoplastic composition according to a formation method comprising one or more of extrusion, injection molding, blow-molding, thermoforming, foaming, compression molding, hot-stamping, fiber spinning, and pultrusion.
